(19) United States
(12) Patent Application Publication
(10) Pub. No.: US 2006/0010034 A1
(43) Pub. Date: Jan. 12, 2006

(54) Method for rewarding purchasing activities and a system thereof

(76) Inventor: Aisha Sparks, Yonkers, NY (US)

Correspondence Address: Gunnar G. Leinberg, Esq.;Nixon Peabody LLP, Clinton Square, P.O. Box 31051, Rochester, NY, 14603-1051, US

(21) Appl. No.: 10/886,783

(22) Filed: Jul. 7, 2004

(51) Int. Cl. G06F 17/00

(52) U.S. Cl. 705/14

(57) ABSTRACT

A method, computer readable medium with programmed instructions, and a system for rewarding one or more purchases in accordance with embodiments of the present invention includes providing an initial reward amount and providing at least one of a benchmark reward amount and a multiple sales reward amount. The initial reward amount is added to a reward balance for an identifier associated with a current sales transaction based on a value of at least one designated good in the current sales transaction. The benchmark reward amount is added to the reward balance to the identifier associated with the current sales transaction based on an accumulated total of completed sales transactions which exceeds at least one benchmark on or after the current sales transaction.

### FIELD OF THE INVENTION

The present invention generally relates to methods and systems for selling goods and, more particularly, to a method for rewarding one or more purchases of designated goods and a system thereof.

### BACKGROUND

As the marketplace becomes increasingly competitive, finding new techniques to increase sales has become more difficult. Retailers have tried to introduce a variety of different types of incentive programs to entice consumers to purchase goods from their stores.

For example, retailers have introduced programs which track purchases of their customers and award a specified number of points based on the purchase amounts. The customers can later redeem those accumulated points against subsequent purchases. Although these types of incentive programs provide some benefit, they do not provide any added incentive for consumers to purchase multiple products or to convince their friends and neighbors to purchase the same products they have purchased.

### SUMMARY

A method for and a computer readable medium with programmed instructions for rewarding one or more purchases in accordance with embodiments of the present invention includes providing an initial reward amount and providing at least one of a benchmark reward amount and a multiple sales reward amount. The initial reward amount is added to a reward balance for an identifier associated with a current sales transaction based on a value of at least one designated good in the current sales transaction. The benchmark reward amount is added to the reward balance to the identifier associated with the current sales transaction based on an accumulated total of completed sales transactions which exceeds at least one benchmark on or after the current sales transaction.

A system for rewarding one or more purchases in accordance with embodiments of the present invention includes an initial reward system and an additional reward system. The initial reward system provides an initial reward amount that is added to a reward balance for an identifier associated with a current sales transaction based on a value of at least one designated good in the current sales transaction. The additional reward system provides a benchmark reward amount which is added to the reward balance to the identifier associated with the current sales transaction based on an accumulated total of completed sales transactions which exceeds at least one benchmark on or after the current sales transaction.

The present invention provides a method and system for increasing the sales of designated goods within a rewards program. With the present invention the consumer is not only motivated to purchase a designated good, but is motivated to purchase multiple designated goods within the same transaction and has an incentive to motivate others, such as relatives, friends, neighbors, and colleagues, to purchase the designated goods they have purchased because these other activities will increase the consumer's reward balance. As a result, the present invention will increase the sales of designated goods and my help to spur additional sales through the sales life of the designated goods.

### BRIEF DESCRIPTION OF THE DRAWINGS

FIG. 1 is a block diagram of a system for rewarding a particular type of purchase in accordance with embodiments of the present invention;

FIG. 2 is a flow chart of a process for registering for a program for rewarding a particular type of purchase in accordance with embodiments of the present invention;

FIGS. 3A-3B are a flow charts of method for rewarding a particular type of purchase in accordance with embodiments of the present invention;

FIG. 4 is a flow chart of a method for determining a reward balance associated with each identifier; and

FIGS. 5A-5B are diagrams of a redemption fund used in the method and system for rewarding a particular type of purchase.

### DETAILED DESCRIPTION

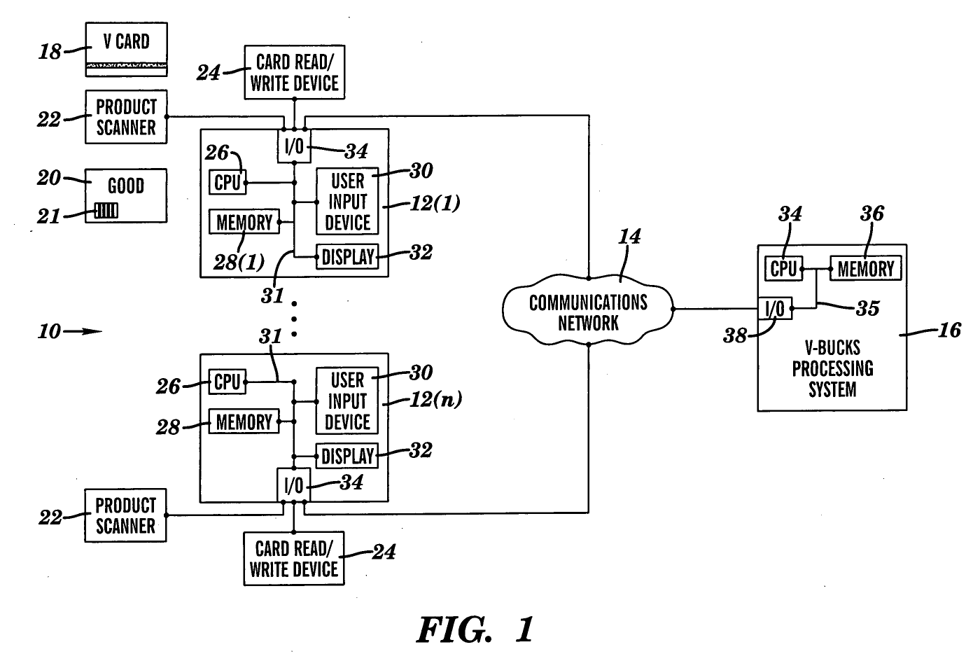

A system 10 for rewarding one or more purchases in accordance with embodiments of the present invention is illustrated in FIG. 1. The system 10 includes a plurality of retail processing systems 12(1)-12(n), a communications network 14, a rewards processing system 16, a product scanner 22, and a card read/write device 24, although the system 10 can comprise other numbers and types of components in other configurations. The present invention provides a number of advantages including providing a sales and marketing method and system which increases the sales of designated goods.

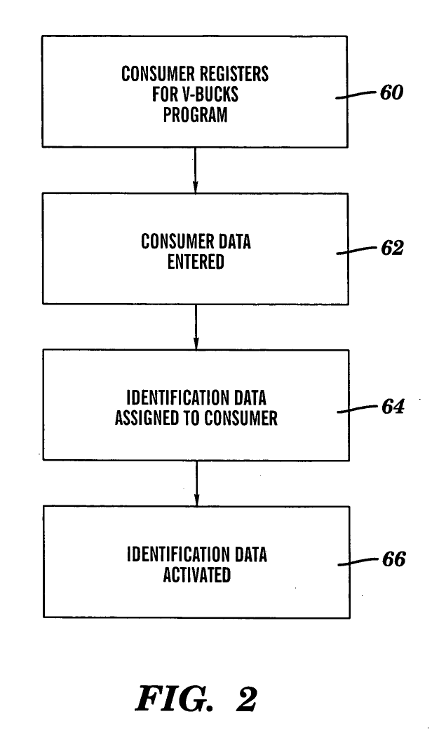

Each of the retail processing systems 12(1)-12(n) include a central processing unit (CPU) or processor 26, a memory 28, a user input device 30, a display 32, and an input/output interface system 34 which are coupled together by a bus 31 or other link, although other types of systems for conducting the transaction comprising other numbers and types of components in other configurations can be used. The processor 26 executes a program of stored instructions for one or more aspects of the present invention as described herein, including the method for rewarding a particular type of purchase as described with reference to FIGS. 2, 3A, 3B, 4, 5A, and 5B.

The memory 28 stores the programmed instructions for one or more aspects of the present invention as described herein, including a portion the method for rewarding on or more purchases as described with reference to FIGS. 2, 3A, 3B, 4, 5A, and 5B, for execution by the processor 26, although some or all of the programmed instructions could be stored and/or executed elsewhere, such as in memory 36 by processor 34 in V-Bucks processing system 16. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for memory 28 to store the programmed instructions described herein, as well as other information.

The user input device 30 enables an operator to generate and transmit signals or commands to the processor 26, such as a request to print or display a reward balance associated with an identifier assigned to a customer. A variety of different types of user input devices could be used for user input device 30, such as a keyboard or computer mouse. The display device 32 displays information for the operator of the particular one of the retail processing systems 12(1)-12(n), such as a reward balance associated with an identifier assigned to a customer. A variety of different types of display devices can be used for display device 32, such as a CRT display.

The input/output interface system 34 is used to operatively couple and communicate between the particular one of the retail processing systems 12(1)-12(n) and other devices and systems, such as the product scanner 22 and the card read/write device 24 associated with that one of the retail processing systems 12(1)-12(n) and the rewards processing system 16. A variety of communication systems and/or methods can be used for the communication network 14 to operatively couple and communicate between the retail processing systems 12(1)-12(n) and the rewards processing system 16, such as a direct connection, a local area network, a wide area network, the world wide web, modems and phone lines, and wireless communication technology each having their own communications protocols.

The product scanner 22 is used to scan a bar code 21 on a designated good 20 to indicate to the associated one of the retail processing systems 12(1)-12(n) that the designated good 20 is part of a current sales transaction, although other types of devices and/or techniques for indicating that a good 20 is part of a current sales transaction can be used. A variety of different types of devices can be used for the product scanner 22, such as a bar code scanner.

The card reading/writing device 24 is used by the associated on the of the retail processing systems 12(1)-12(n) to read information from and/or to write information to a card 18. Although a card reading/writing device 24 is shown, other types of devices, such as a card reader, a card writer, or other system for entering identification information could be used. The card 18, known as the identification card or V-card in these embodiments, is used to store unique identification information associated with a particular consumer and may also be used to store information related to the particular consumer's reward balance. The card 18 may include a magnetic strip or may have another device or technique for storing the data.

The rewards processing system 16, also referred to as a V-Bucks processing system herein, includes a central processing unit (CPU) or processor 34, a memory 36, and an input/output interface device 38 which are coupled together by a bus 35 or other link, although other types of systems comprising other numbers and types of components in other configurations can be used. The processor 34 executes a program of stored instructions for one or more aspects of the present invention as described herein, including the method for rewarding one or more purchases as described with reference to FIGS. 2, 3A, 3B, 4, 5A, and 5B. The memory 28 stores the programmed instructions for one or more aspects of the present invention as described herein, including a portion the method for rewarding a particular type of purchase as described with reference to FIGS. 2, 3A, 3B, 4, 5A, and 5B, for execution by the processor 26, although some or all of the programmed instructions could be stored and/or executed elsewhere, such as in memory 28 by processor 26 in one or more of the retail processing systems 12(1)-12(n). A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for memory 36 to store the programmed instructions described herein, as well as other information. The input/output interface system 38 is used to operatively couple and communicate between the rewards processing system 16 and one or more of the retail processing systems 12(1)-12(n).

A method for establishing a reward system for one or more purchases will now be described with reference to FIGS. 2, 3A, 3B, 4, 5A, and 5B. Referring more specifically to FIG. 2, in step 60 a consumer registers for the rewards program, also referred to as the V-Buck's program herein. The consumer can register for this program in a variety of different manners, such as through an on-line registration form at a participating retailer's internet web-site, by mailing in a completed registration form, or by completing a registration form at a participating retailer.

In step 62, the data from the consumer is entered into the rewards processing system 16 and is stored in memory 36, although the data can be entered and stored at other locations, such as in one or more of the memories 28 in the retail processing systems 12(1)-12(n). When the data is entered, the rewards processing system 16 assigns a unique identifier comprising identification data that is associated to the registering consumer and this identifier is stored in memory 36, although the identifier can be entered and stored at other locations, such as in one or more of the memories 28 in the retail processing systems 12(1)-12(n). The identifier is also written into the magnetic strip of the card 18 by the card read/write device 24 at one of the retail processing systems 12(1)-12(n), although the identifier could be entered on the card 18 in other manners and mailed to the consumer and other manners for providing the identifier to the consumer can also be used. In step 66, the rewards processing system 16 activates the identifier to allow activities, such as monitoring transactions and providing reward amounts to a reward balance associated with the identifier.

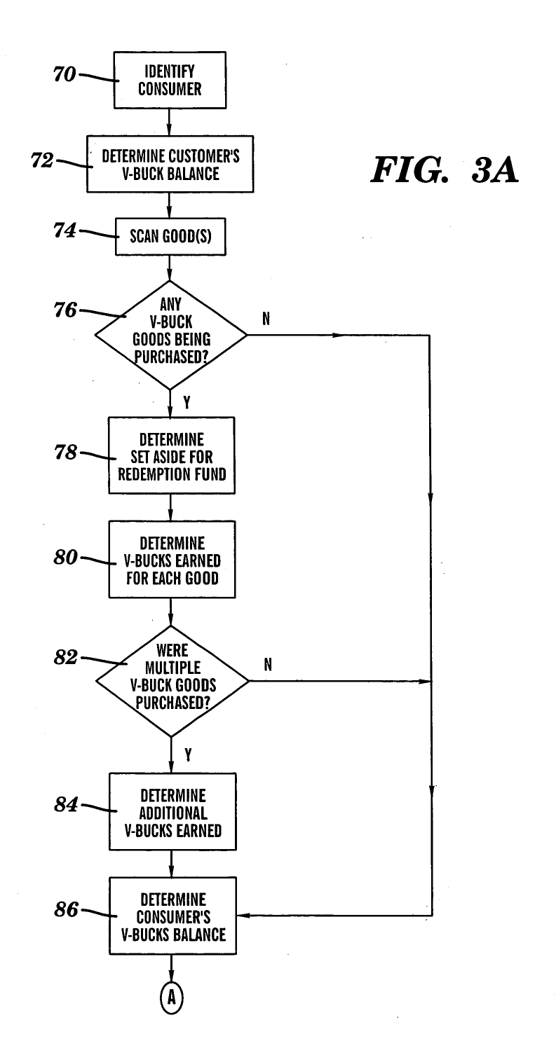

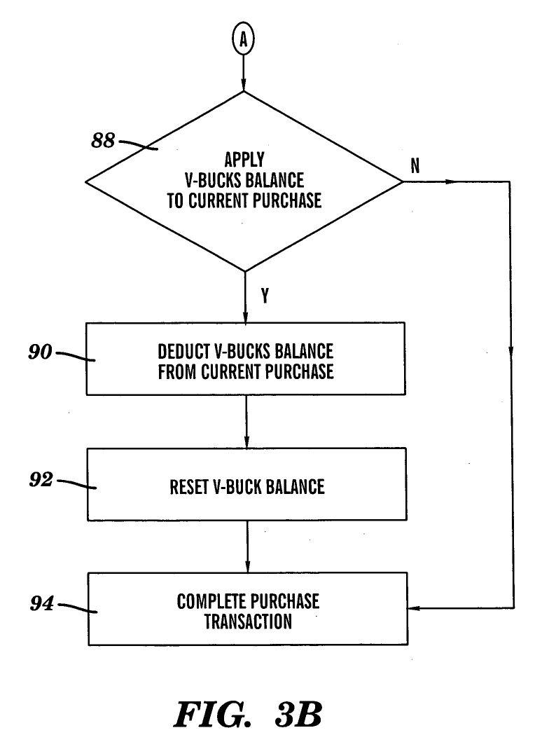

Referring to FIG. 3A, in Step 70 a consumer at a participating retailer that wishes to make a purchase presents a card 18 which is read by the card read/write device 24 at one of the retail processing systems 12(1)-12(n) to provide an identifier. The one of the retail processing systems 12(1)-12(n) communicates with the rewards processing system 16 via the communication network 14 to confirm the identity of the consumer based on the identifier obtained by the card read/write device 24, although other manners for obtaining the identifier from a consumer can be used, such as by manually entering the identifier at the user input device 30 at one of the retail processing systems 12(1)-12(n).

In step 72, the one of the retail processing systems 12(1)-12(n) that obtained the identifier from the consumer, communicates with the rewards processing system 16 via the communications network 14 to determine the reward balance, also referred to as the V-bucks balance herein, associated with the identifier obtained in step 70.

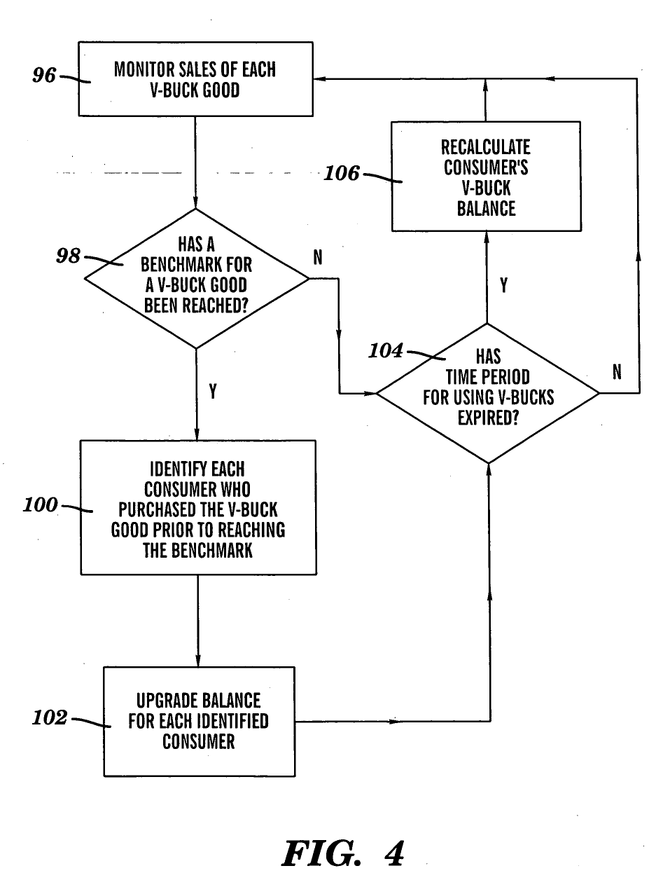

The process for determining the reward balance associated with the entered identifier and also for other identifiers is described in greater detail with reference to FIG. 4. In step 96, the rewards processing system 16 monitors the sale of each designated good 20 by one or more of the retail processing systems 12(1)-12(n). For ease of illustration, only one designated good 20 is illustrated in FIG. 1, but typically there will be a large volume of designated goods which can be purchased and are part of this program. Although in these embodiments, the sale of a particular designated good 20 is monitored, other types of accumulated total sales transactions after the current sale transaction of the designated good 20 can be monitored to determine when to reward the benchmark reward amount. By way of example only, an accumulated total of completed sales transactions for a brand of goods which correspond to the brand of the designated good 20, an accumulated total of completed sales transactions at an individual store where the designated good 20 was purchased, or an accumulated total of completed sales transactions at a chain of stores where the designated good was purchased from one of the stores in the chain could also be monitored.

In step 98, the rewards processing system 16 continually monitors the sale of each designated good 20 in subsequent sales transactions and compares the total number of sales of each good 20 against one or more benchmarks for sales set for each good 20 to determine if the benchmark has been reached. The benchmarks used in these comparisons are stored in memory 36 in rewards processing system 16, although the benchmark or benchmarks for each good 20 can be stored in other locations, such as in the memory 28 in one or more of the retail processing systems 12(1)-12(n). Although in this example the benchmark is a total number of sales, other types of and numbers of benchmarks can be used. If in step 98 a benchmark for the good 20 has not been reached, then the No branch is taken to Step 104. If in step 98 a benchmark for a good 20 has been reached, then the Yes branch is taken to step 100.

In step 100, the rewards processing system 16 identifies each identifier stored in the memory 36 that is associated with the purchase of the good 20 prior to reaching the benchmark with subsequent sales transactions involving the designated good or goods. The rewards processing system 16 also determines the benchmark reward amount, also referred to as the V-Buck amount herein, for reaching each of the benchmarks for each of the goods. The amount of each benchmark reward amount can be stored in memory 36 in the rewards processing system 16, although the benchmark rewards amount can be stored in other locations, such as in memory 28 in one of the retail processing systems 12(1)-12(n) or the reward balance amount could be calculated in other manners. By way of example only, the benchmark reward amount for different designated goods is illustrated below:

### BENCHMARK REWARD AMOUNT EXAMPLE 1

Jay-Z The Black Album

| | |
|---|---|
| 500,000 Sold | Additional Benchmark Reward Amount = 15 |
| 1 Million Sold | Additional Benchmark Reward Amount = 5 |

### BENCHMARK REWARD AMOUNT EXAMPLE 2

| | |
|---|---|
| Scarface 20^{th} | |
| Anniversary DVD | |
| 500,000 DVD's sold | Additional Benchmark Reward Amount = 15 |

### BENCHMARK REWARD AMOUNT EXAMPLE 3

| | |
|---|---|
| Rush Hour 2 DVD | |
| 1 Million DVD's sold | Additional Benchmark Reward Amount = 20 |

### BENCHMARK REWARD AMOUNT EXAMPLE 4

| | |
|---|---|
| Avant “Private Room” | |
| 500,000 CD's Sold | Additional Benchmark Reward Amount = 15 |

In step 102, the rewards processing system 16 upgrades a reward balance for each identifier which purchased the good 20 prior to the good reaching the benchmark with the additional benchmark reward amount. The rewards processing system 16 stores the reward balance for each identifier in memory 36, although the updated reward balance can be stored in other locations, such as in the memory in one of the retail processing systems 12(1)-12(n). To help entice the sales of particular goods, participating retailers may mark the goods with an indicator, such as a gold or silver seal, to indicate that the good is close to reaching a benchmark. A consumer may be more likely to purchase a good 20 which is close to a benchmark to get the additional benchmark reward amount.

Next, in step 104 the rewards processing system 16 tracks time for each reward balance from a starting or resetting point. The rewards processing system 16 also determines if a time period which has passed for any reward balance from the starting and resetting point exceeds a set time period for using the reward balance, such as a one year time period, although other time periods and manners for monitoring an expiration of a reward balance could be used. The rewards processing system 16 continually checks all of the stored reward balances, although other arrangements could be used. If in step 104 the time period for using the reward balance has not expired, then the No branch is taken back to Step 96. If the time period for using the reward balance has expired, then the Yes branch is taken to step 106. In step 106, the reward balance which has not been used in time is reset to a base value, such as zero, although other manners for resetting the reward balance can be used.

Referring back to FIG. 3A, in step 74 during a current sales transaction any goods that the consumer is purchasing are scanned in using the product scanner 22 at one of the retail processing systems 12(1)-12(n) ( 1 ), although other manners for entering the information about the goods being purchased can be used.

In step 76 the one of the retail processing systems 12(1)-12(n) associated with the current sales transaction determines whether any designated goods, such as good 20, are part of the current sales transaction. Designated goods are products or services, such as good 20 by way of example only, that are participating in this program. Good 20 includes a bar code 21 which includes information that indicates that the good is participating in the program, although other manners for indicating that a good being purchased is a designated good can be used. If the current sales transaction does not include any designated goods, then the No branch is taken to step 86. If one or more designated goods are being purchased in the current sales transaction, then the Yes branch is taken to step 78.

In step 78, the one of the retail processing systems 12(1)-12(n) associated with the current sales transaction determines an amount to set aside for a redemption fund which is used to cover the costs. In these embodiments, the one of the retail processing systems 12(1)-12(n) sets aside four percent of the total sales price for designated goods in the transaction for the redemption fund.

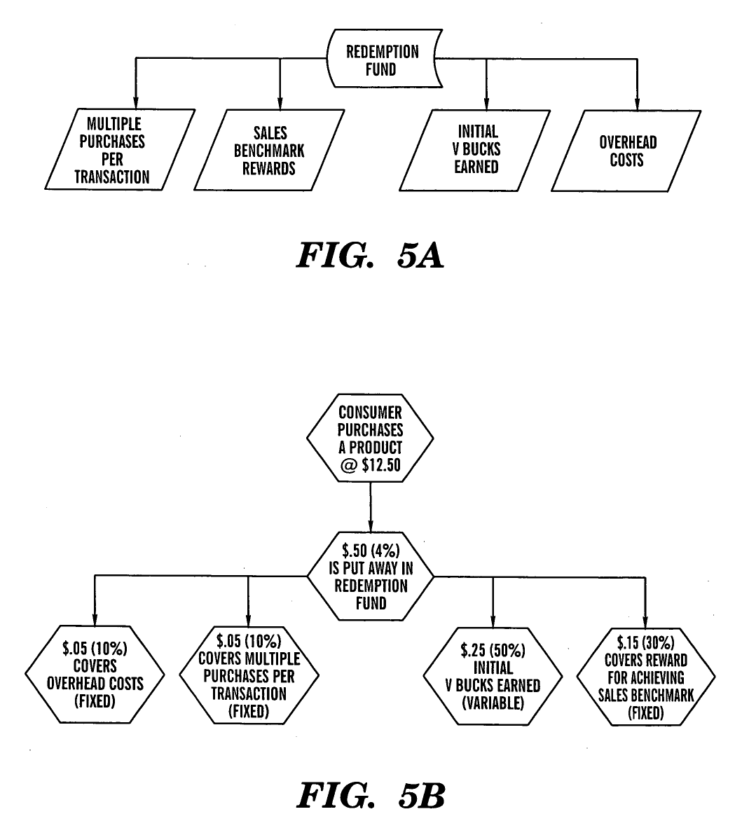

Referring FIGS. 5A-5B, diagrams illustrating one example of how a redemption fund can be broken down are illustrated. As shown in FIG. 5A, the redemption fund is further broken into four portions: a multiple purchase per transaction portion; a sales benchmark rewards portion; an initial reward amount; and overhead costs. As shown in FIG. 5B, an example of how the redemption fund is determined and broken down is illustrated. In this example, for the sales of one designated good for $12.50, $0.50 is designated for the redemption fund and this is further broken down to: $0.05 for multiple purchases; $0.15 for the sales benchmark reward amount; $0.25 for the initial reward amount; and $0.05 for the overhead costs. The redemption fund illustrated in FIGS. 5A-5B is by way of example only and the redemption fund can be determined and broken down in other manners.

Referring back to FIG. 3A, in step 80 the one of the retail processing systems 12(1)-12(n) associated with the current sales transaction determines an initial reward amount earned for each designated good in the current sales transaction. By way of example only, when a single designated good, such as the “The Black Album” by Jay-Z is purchased as part of the current sales transaction, the initial reward amount is:

### INITIAL REWARD AMOUNT EXAMPLE 1

### (Single CD Purchase)

| | | | | |
|---|---|---|---|---|
| Jay-Z | “The Black Album” | 15.99 | initial reward amount | 32 |
| | | TOTAL | | 32 |

The initial reward amount is transmitted from the one of the retail processing systems 12(1)-12(n) to the rewards processing system 16 and is added to the reward balance associated with the identifier for the current sales transaction in the rewards processing system 16, although other manners for maintaining and updating the rewards balances can be used.

In step 82, the one of the retail processing systems 12(1)-12(n) associated with the current sales transaction determines whether or not multiple designated goods were purchased. If multiple one of the retail processing systems 12(1)-12(n) that scanned in the good or goods for the current sales transaction goods were not purchased, then the No branch is taken to Step 86. If multiple one of the retail processing systems 12(1)-12(n) that scanned in the good or goods for the current sales transaction goods were purchased, then the Yes branch is taken to step 84.

In step 84, the one of the retail processing systems 12(1)-12(n) associated with the current sales transaction determines the multiple sales reward amount for purchasing multiple designated goods. This multiple sales reward amount is in addition to the initial sales reward amount that is earned for purchasing designated goods. This provides the consumer with an added incentive to purchase multiple designated goods. By way of example only, a determination of the initial reward amounts and the multiple sales reward amounts is illustrated below:

### MULTIPLE SALES REWARD AMOUNT EXAMPLE 1

### Multiple CD Purchase

| | | | | |
|---|---|---|---|---|
| Jay-Z | “The Black Album” | 15.99 | Initial reward amount | 32 |
| Beyonce | “Dangerously | 13.45 | Initial reward amount | 27 |
| | in Love” | | | |
| Alicia Keys | “The Diary of | 15.99 | Initial reward amount | 32 |
| | Alicia Keys” | | | |

| | |
|---|---|
| Added to rewards balance for two additional designated goods | 10 |

purchased

| | |
|---|---|
| Total reward amount earned | 101 |

### MULTIPLE SALES REWARD AMOUNT EXAMPLE 2

### DVD and CD Purchase

| | | | |
|---|---|---|---|
| Scarface 20^{th} Anniversary DVD | 19.99 | Initial reward amount | 40 |
| Rush Hour 2 DVD | 16.99 | Initial reward amount | 34 |
| Avant “Private Room” | 15.99 | Initial reward amount | 32 |

| | |
|---|---|
| Added to rewards balance for two additional designated goods | 10 |

purchased

| | |
|---|---|
| Total reward amount earned | 116 |

### MULTIPLE SALES REWARD AMOUNT EXAMPLE 3

### Consumer Goods Mixed

| | | | |
|---|---|---|---|
| Sony Walkman | 49.99 | Initial reward amount | 100 |
| 50 Cent “Get Rich or Die Tryin” | 15.99 | Initial reward amount | 32 |

| | |
|---|---|
| Added to rewards balance for one additional designated good | 5 |

purchased

| | |
|---|---|
| Total reward amount earned | 137 |

In step 86, the multiple sales reward amount is transmitted from the one of the retail processing systems 12(1)-12(n) associated with the current sales transaction to the rewards processing system 16 and is added to the reward balance associated with the identifier for the current sales transaction in the rewards processing system 16, although other manners for maintaining and updating the rewards balances can be used. The retail processing system 16 determined the new reward balance associated with the identifier which is forwarded back to the one of the retail processing systems 12(1)-12(n) associated with the current sales transaction.

Referring to FIG. 3B, in step 88 the one of the retail processing systems 12(1)-12(n) associated with the current sales transaction makes an inquiry on whether or not to apply the reward balance associated with the identifier for the current sales transaction against the current purchase price. If the reward balance is not going to be applied against the current purchase price, then the No branch is taken to step 94 where the transaction is completed in a conventional manner. If the consumer associated with the identifier desires to apply the reward balance against the current purchase price, then the Yes branch is taken to step 90.

In step 90, the one of the retail processing systems 12(1)-12(n) associated with the current sales transaction determines deducts the reward balance from the current purchase price. The reward balance is converted from a reward value to a monetary value by the one of the retail processing systems 12(1)-12(n) associated with the current sales transaction and is then subtracted from the current purchase price, although other manners for handling the reward balance can be used. For example, the reward value may be accumulated in a manner which is equivalent to a monetary value and thus would not need to be converted. By way of example only, current sales transactions where the reward balance is applied against the current purchase price are illustrated below:

### Redeeming Against a Single Product Purchase

### EXAMPLE 1

| | | |
|---|---|---|
| DVD “Scarface: The 20 Year | Total | 19.99 |
| Anniversary” | | |
| Current Reward Balance = 180 | | −1.80 |
| | Price After Redeeming | $18.19 |

### Redeeming Against a Multiple Product Purchase

### EXAMPLE 2

| | | |
|---|---|---|
| DVD “Scarface: The 20 Year | | 19.99 |
| Anniversary” | | |
| DVD “Rush Hour” | | 19.99 |
| CD Jay-Z “Black Album” | | 15.99 |
| | Total | $55.97 |
| Current Reward Balance = 850 | | −8.50 |
| | Price After Redeeming | $47.47 |

In step 92, the one of the retail processing systems 12(1)-12(n) associated with the current sales transaction signals the rewards processing system 16 that the reward balance has been used. The reward processing system 16 resets the reward balance for the identifier associated with the current sales transaction which applied the reward balance to zero, although the reward balance could be reset to other values. In step 94, the current sales transaction is completed in conventional manners.

As the above discussion and examples have illustrated, the present invention provides a consumer with an incentive for purchasing one or more designated goods, to purchase a greater quantity of designated goods, and convince others to buy the designated goods they have purchased so they can receive added reward amounts if a benchmark is reached. As a result, the present invention will help to increase sales of designated goods.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A method for rewarding one or more purchases, the method comprising:
providing an initial reward amount which is added to a reward balance for an identifier associated with a current sales transaction based on a value of at least one designated good in the current sales transaction; and
providing a benchmark reward amount which is added to the reward balance to the identifier associated with the current sales transaction based on an accumulated total of completed sales transactions which exceeds at least one benchmark on or after the current sales transaction.

2. The method as set forth in claim 1 wherein the accumulated total of completed sales transactions comprises an accumulated total of completed sales transactions for at least one of the at least one designated good, a brand of goods, at an individual store, and at a chain of stores.

3. The method as set forth in claim 2 wherein the providing the at least one of a benchmark reward amount further comprises:
tracking subsequent sales transactions of the at least one of the at least one designated good, the brand of goods, at the individual store, and at the chain of stores, wherein the subsequent sales transactions are associated with one or more of a plurality of the identifiers;
recording each of the identifiers associated with one of the subsequent sales transactions;
determining when the accumulated total of completed sales transactions exceeds the at least one benchmark; and
providing the benchmark reward to each of the recorded identifiers associated with each of the subsequent sales transactions which occurred prior to or upon reaching the benchmark.

4. The method as set forth in claim 1 providing a multiple sales reward amount which is added to the reward balance to the identifier associated with the current sales transaction based on having more than one of the designated goods in the current sales transaction, wherein the multiple sales reward amount is in addition to the initial reward amount for each of the designated goods purchased.

5. The method as set forth in claim 4 wherein the providing a multiple sales reward amount further comprises:
determining a number of the designated goods in the current sales transaction; and
determining the multiple sales reward amount based on the determined number of designated goods; and
providing the determined multiple sales reward amount to the identifier associated with the current sales transaction.

6. The method as set forth in claim 1 further comprising obtaining the identifier associated with the current sales transaction.

7. The method as set forth in claim 1 further comprising determining if a current sales transaction involves at least one designated good, wherein the providing the initial reward amount and the providing the at least one benchmark reward amount is based on the determining indicating that at least one of the designated goods is being purchased.

8. The method as set forth in claim 1 further comprising designating a portion of a payment received for the current sales transaction for a redemption fund for the reward balance associated with the identifier.

9. The method as set forth in claim 1 further comprising displaying the reward balance associated with the identifier.

10. The method as set forth in claim 1 further comprising resetting the reward balance to a starting balance if a time period has expired.

11. The method as set forth in claim 1 further comprising:
determining if the reward balance associated with the identifier for the current sales transaction is to be used against a total sales price for the current sales transaction; and
reducing the total sales price by the reward balance if the determining indicates the reward balance is to be used against the total sales price.

12. A computer readable medium having stored thereon instructions for rewarding one or more purchases which when executed by a processor, causes the processor to perform steps comprising:
providing an initial reward amount which is added to a reward balance for an identifier associated with a current sales transaction based on a value of at least one designated good in the current sales transaction; and
providing a benchmark reward amount which is added to the reward balance to the identifier associated with the current sales transaction based on an accumulated total of completed sales transactions which exceeds at least one benchmark on or after the current sales transaction.

13. The medium as set forth in claim 1 wherein the accumulated total of completed sales transactions comprises an accumulated total of completed sales transactions for at least one of the at least one designated good, a brand of goods, at an individual store, and at a chain of stores.

14. The medium as set forth in claim 13 wherein the providing the at least one of a benchmark reward amount further comprises:
tracking subsequent sales transactions of the at least one of the at least one designated good, the brand of goods, at the individual store, and at the chain of stores, wherein the subsequent sales transactions are associated with one or more of a plurality of the identifiers;
recording each of the identifiers associated with one of the subsequent sales transactions;
determining when the accumulated total of completed sales transactions exceeds the at least one benchmark; and
providing the benchmark reward to each of the recorded identifiers associated with each of the subsequent sales transactions which occurred prior to or upon reaching the benchmark.

15. The method as set forth in claim 12 providing a multiple sales reward amount which is added to the reward balance to the identifier associated with the current sales transaction based on having more than one of the designated goods in the current sales transaction, wherein the multiple sales reward amount is in addition to the initial reward amount for each of the designated goods purchased.

16. The method as set forth in claim 15 wherein the providing a multiple sales reward amount further comprises:
determining a number of the designated goods in the current sales transaction; and
determining the multiple sales reward amount based on the determined number of designated goods; and
providing the determined multiple sales reward amount to the identifier associated with the current sales transaction.

17. The medium as set forth in claim 12 further comprising obtaining the identifier associated with the current sales transaction.

18. The medium as set forth in claim 12 further comprising determining if a current sales transaction involves at least one designated good, wherein the providing the initial reward amount and the providing the at least one benchmark reward amount is based on the determining indicating that at least one of the designated goods is being purchased.

19. The medium as set forth in claim 12 further comprising designating a portion of a payment received for the current sales transaction for a redemption fund for the reward balance associated with the identifier.

20. The medium as set forth in claim 12 further comprising displaying the reward balance associated with the identifier.

21. The medium as set forth in claim 12 further comprising resetting the reward balance to a starting balance if a time period has expired.

22. The medium as set forth in claim 12 further comprising:
determining if the reward balance associated with the identifier for the current sales transaction is to be used against a total sales price for the current sales transaction; and
reducing the total sales price by the reward balance if the determining indicates the reward balance is to be used against the total sales price.

23. A system for rewarding one or more purchases, the system comprising:
an initial reward system that provides an initial reward amount that is added to a reward balance for an identifier associated with a current sales transaction based on a value of at least one designated good in the current sales transaction; and
an additional reward system that provides a benchmark reward amount which is added to the reward balance to the identifier associated with the current sales transaction based on an accumulated total of completed sales transactions which exceeds at least one benchmark on or after the current sales transaction.

24. The system as set forth in claim 23 wherein the accumulated total of completed sales transactions comprises an accumulated total of completed sales transactions for at least one of the at least one designated good, a brand of goods, at an individual store, and at a chain of stores.

25. The system as set forth in claim 24 wherein the additional reward system further comprises:
a tracking system that tracks-subsequent sales transactions of the at least one of the at least one designated good, the brand of goods, at the individual store, and at the chain of stores, wherein the subsequent sales transactions are associated with one or more of a plurality of the identifiers;
a recording system that records each of the identifiers associated with one of the subsequent sales transactions; and
a benchmark system that determines when the accumulated total of completed sales transactions exceeds the at least one benchmark;
wherein the additional reward system provides the benchmark reward to each of the recorded identifiers associated with each of the subsequent sales transactions which occurred prior to or upon reaching the benchmark.

26. The system as set forth in claim 23 further comprising a multiple sales reward system that provides a multiple sales reward amount which is added to the reward balance to the identifier associated with the current sales transaction based on having more than one of the designated goods in the current sales transaction, wherein the multiple sales reward amount is in addition to the initial reward amount for each of the designated goods purchased.

27. The system as set forth in claim 26 wherein the multiple sales reward system further comprises:
a totaling system that determines a number of the designated goods in the current sales transaction; and
a reward determination system that determines the multiple sales reward amount based on the determined number of designated goods;
wherein the multiple sales reward system provides the determined multiple sales reward amount to the identifier associated with the current sales transaction.

28. The system as set forth in claim 23 further comprising a login system that obtains the identifier associated with the current sales transaction.

29. The system as set forth in claim 23 further comprising an identification system that determines if a current sales transaction involves at least one designated good, wherein operation of the initial reward system and the additional reward system is based on the identification system determining that at least one of the designated goods is being purchased.

30. The system as set forth in claim 23 further comprising a redemption processing system that designates a portion of a payment received for the current sales transaction for a redemption fund for the reward balance associated with the identifier.

31. The system as set forth in claim 23 further comprising a display system that displays the reward balance associated with the identifier.

32. The system as set forth in claim 23 further comprising an expiration monitoring system that resets the reward balance to a starting balance if a time period has expired.

33. The system as set forth in claim 23 further comprising:
a rewards redemption system that determines if the reward balance associated with the identifier for the current sales transaction is to be used against a total sales price for the current sales transaction; and
a sales processing system that reduces the total sales price by the reward balance if the determining indicates the reward balance is to be used against the total sales price.
